(19) United States
(12) Patent Application Publication
(10) Pub. No.: US 2011/0258430 A1
(43) Pub. Date: Oct. 20, 2011

(54) METHOD AND APPARATUS FOR APPLYING EXECUTION CONTEXT CRITERIA FOR EXECUTION CONTEXT SHARING

(75) Inventors: Vesa-Veikko Luukkala, Espoo (FI); Sampo Juhani Sovio, Riihimaki (FI); Sergey Boldyrev, Soderkulla (FI); Jukka Honkola, Espoo (FI); Hannu Laine, Espoo (FI); Mika Mannermaa, Burlington, MA (US); Ian Justin Oliver, Soderkulla (FI)

(73) Assignee: Nokia Corporation, Espoo (FI)

(21) Appl. No.: 12/761,005

(22) Filed: Apr. 15, 2010

(51) Int. Cl. H04L 9/00

(52) U.S. Cl. 713/150

(57) ABSTRACT

An approach is provided for applying execution context criteria for secure execution context sharing. A criterion application retrieves an execution context of a device. The criterion application determines one or more context criteria associated with the execution context. The context criteria include state information associated with the execution context. The criterion application encrypts the execution context using the one or more context criteria as a public key of an identity-based encryption.

### BACKGROUND

Network service providers (e.g., wireless, cellular, Internet, content, social network, etc.) and device manufacturers are continually challenged to deliver value, convenience, and security to consumers by, for example, providing compelling network services. Also, significant information growth in last decade compels service provider and device manufacturers to consider the most significant parameters of the operational modes of these services. One area on interest has been consideration of efficient and persistent execution contexts (e.g., the memory states, processors states, and related information of device when executing a particular application or service) as essential part of computing platform. This consideration has more importance when dealing with constrained computing environment such as a mobile device (e.g., smartphone, handset, tablet, electronic book, etc.) where execution contexts may be more commonly shared among different devices. In other words, an important part of the execution context is instantiating the execution context and/or other related contexts in different computational entities. It is important to have control on the context migration as the context is communicated across potentially insecure channels. Public key cryptography is a widely used encryption/decryption method to protect data. However, use of long and randomly generated encryption keys and management and storage of encryption/decryption keys, encryption/decryption criteria, certificate, etc., are becoming daunting as the number of users, computing platforms, etc. are increasing.

### SOME EXAMPLE EMBODIMENTS

Therefore, there is a need for an approach for applying execution context criteria for secure execution context sharing.

According to one embodiment, a method comprises retrieving an execution context of a device. The method also comprises determining one or more context criteria associated with the execution context. The context criteria include state information associated with the execution context. The method further comprises encrypting the execution context using the one or more context criteria as a public key of an identity-based encryption.

According to another embodiment, an apparatus comprising at least one processor, and at least one memory including computer program code, the at least one memory and the computer program code configured to, with the at least one processor, cause, at least in part, the apparatus to retrieve an execution context. The apparatus is also caused to determine one or more context criteria associated with the execution context. The context criteria include state information associated with the execution context. The apparatus is further caused to encrypt the execution context using the one or more context criteria as a public key of an identity-based encryption.

According to another embodiment, a computer-readable storage medium carrying one or more sequences of one or more instructions which, when executed by one or more processors, cause, at least in part, an apparatus to retrieve an execution context. The apparatus is also caused to determine one or more context criteria associated with the execution context. The context criteria include state information associated with the execution context. The apparatus is further caused to encrypt the execution context using the one or more context criteria as a public key of an identity-based encryption.

According to another embodiment, an apparatus comprises means for retrieving an execution context of a device. The apparatus also comprises means for determining one or more context criteria associated with the execution context. The context criteria include state information associated with the execution context. The apparatus further comprises means for encrypting the execution context using the one or more context criteria as a public key of an identity-based encryption.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of applying execution context criteria for secure execution context sharing, according to one embodiment;

FIG. 2 is a diagram of the components of a criterion application, according to one embodiment;

FIGS. 3A-3C are flowcharts of processes for applying execution context criteria for secure execution context sharing, according to various embodiments;

FIGS. 4A and 4B are diagrams of a binary decision diagram and a corresponding reduced ordered binary decision diagram, according to one embodiment;

FIG. 5 is a utilization diagram of the process for applying execution context criteria for secure execution context sharing, according to one embodiment;

FIG. 6 is an operational diagram for content encryption using execution context criteria, according to one embodiment;

FIG. 7 is a diagram of a smart space structure for of applying execution context criteria for secure execution context sharing, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for applying execution context criteria for secure execution context sharing are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various exemplary embodiments are described with respect to identity-based encryption (IBE), it is contemplated that these embodiments have applicability to any encryption mechanism such as any public key encryption mechanism. By way of example, IBE is keyed to criteria (e.g., characteristics, properties, interests, etc.) associated with potential recipients as opposed to specific recipients. In this way, IBE enables distribution of content, messages, data, etc. to target recipients without knowing the identities of the target recipients.

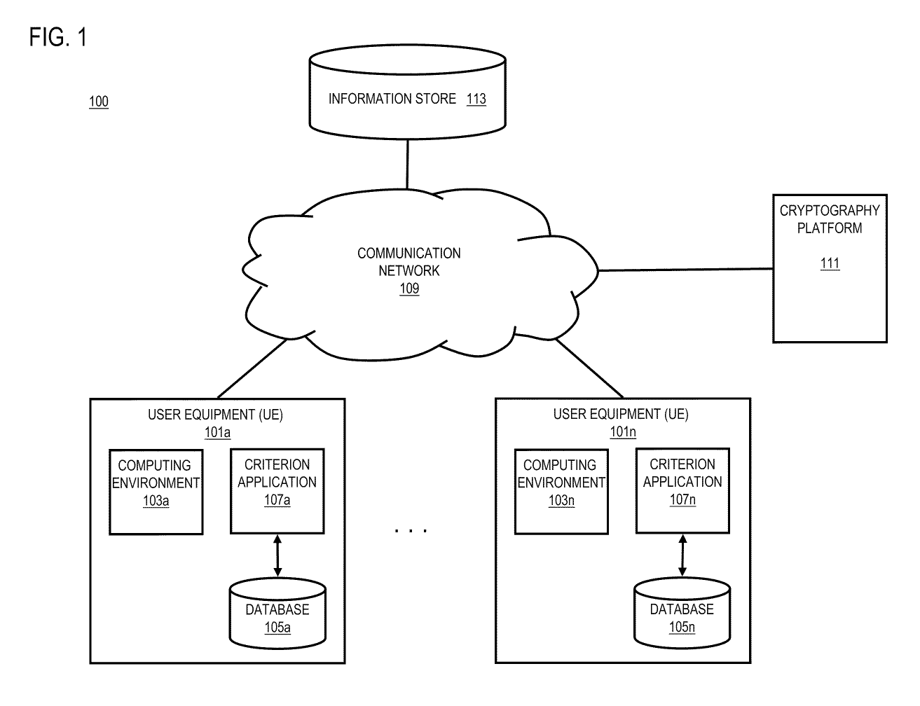

FIG. 1 is a diagram of a system capable of applying execution context criteria for secure execution context sharing, according to one embodiment. In the view of digital convergence in information creation, processing, and distribution processes, it is a big challenge to leverage the information processing power in a most efficient way of any given computing environment. Due to coexistence and interaction of different basic technologies (for example, for memory design and manufacturing) and consideration of the shift of computing paradigm in the view of, for example, energy consumption, performance and reliability factors, existence of computing platforms and memories with hybrid properties in response time and data persistence offer advantages in flexibility, performance, etc. Given that modern technologies can provide the solution for such memory, computing environments should be built in such a way that can provide seamless and persistent utilization of their computing units and memory in a most efficient ways.

During the last decade almost exponential information growth is taking place. It is the matter of system design to consider the most significant parameters of the operational modes for utilizing the information. In particular, for memory in embedded devices one can consider at least three important dimensions during any design stage, including data reliability, performance, and energy costs. The data reliability parameter can be affected by all means of material properties (e.g., design and configuration) as well as by functions like error correction code (ECC), parity checking, the way how defects are mapped out, etc. From the performance perspectives, system design can be directed to improving latency, capacity, power management, and the like. The reliability and performance parameter can then be integrated in light of the cost function to arrive at operational modes and/or specifying the most appropriated computing platform to perform a given task or function. At the very basic level, any computing platform can include execution pipeline and memory facilities that are in charge of keeping the code and data for the further execution and memory access. Thus, applications and information allocation-wise the main constraints can be the result of the amount of such execution memory, facilities that are providing random access and high performance within the reasonable cost structure (e.g., energy, material, etc.). In the approach described herein, the execution context represents all or a portion of the states of such execution memory at various levels of granularity (e.g., at the level of the processor, memory registers within the process, execution states of applications, etc.).

Additionally, one important aspect of the execution context is instantiating the context in different computing environments and/or computational entities (e.g., execution context sharing among devices). In this way, context sharing enables a user to continue or transfer an execution context from one user device to another or share the context with another user so that the shared execution context can be recreated on the other user's device. However, as part of the context sharing process, it is important to have control on context migration as the execution context can be communicated across potential insecure channels. Also, the consistency of the execution context, as communicated across potentially insecure channels, is important. Moreover, parts of the execution context may not be safe to be published without at least some form of encryption. Public key cryptography is a widely used encryption/decryption method to protect data. However, use of long and randomly generated encryption keys and management and storage of encryption/decryption keys, encryption/decryption criteria, certificate, etc., are becoming daunting as the number of users, computing platforms, etc. are increasing. Further, the particular problem in publishing the execution context is how to publish the context with one or more criteria so that only intended recipients meeting execution context criteria can decrypt or otherwise access the shared execution context.

To address these problems, a system 100 of FIG. 1 can advantageously apply execution context criteria for secure execution context sharing. This approach can be addressed by heterogeneous computing environments, where execution context (e.g., status and service registers, code/data grains schemes, etc.) can be pushed/pulled to/from other computing environments (e.g., master/slave states). Therefore, execution context dependent functional elements of the computing environments can be efficiently uploaded to targeted environments from sourced environments. According to certain embodiments, encrypting execution context with certain portions of the execution context (and/or derived from the certain portions of the execution context) can advantageously guarantee that execution of the context may continue in computing environments that are in the intended state. According to certain embodiments, the use of public key cryptography schemes (such as, but not limited to, identity-based encryption (IBE)) can enable enforcement of policy concerning the execution and security. It is possible to define various rules and conditions of how migration of the execution context can happen.

According to certain embodiments, the system 100 of FIG. 1 can include one or more user equipment (UEs) 101a-101n. For the illustration purposes, the UEs 101a-101n can include computing environments 103a-103n used, for example, for execution processes. Although the computing environments 103a-103n are illustrated in FIG. 1 as part of UEs 101a-101n, it is contemplated that any other computing platforms (such as, but not limited to, application service platforms, web service platforms, communication platform, etc.) can be considered as computing environments. According to certain embodiments, the computing environments 103a-103n can include elements such as, but not limited to, processing units, memory, etc., configured to perform necessary processes.

In one embodiment, the computing environment 103a of the UE 101a is executing a process. The computing environment 103a, UE 101a, other network entities, and/or a user of the UE can decide to continue the execution of the process in another computing environment, such as, the computing environment 103n of the UE 101n. According to certain embodiments, the system 100 of FIG. 1 can advantageously apply execution context criteria to securely share the execution context between the computing environments 103a and 103n. In one example, the computing environments 103a and 103n can access the information store 113 as, for example, a shared information store, through the communication network 109, to store and retrieve the execution context that is to be shared. In one embodiment, the information store 113 can be a shared information store, a network service, a network storage, complete or part of storage devices of the UEs, etc. Accordingly, the information store 113 can be a public storage that different users, UEs, applications, etc., can access. In one example, the information store 113 can include and/or be in communication with databases 105a-105n. Therefore, the execution context that is to be shared between the computing environments 103a and 103n (or a representation of the execution context) needs to be secured such that only the authorized entities can access, before it is published to the information store. It is contemplated that the system 100 of FIG. 1 can advantageously perform the application of execution context criteria for secure execution context sharing using mobile cloud computing.

According to certain embodiments, the UE 101a can include a criterion application 107a configured to determine, apply execution context criteria, secure, and publish the execution context that is to be shared with the computing environment 103n. Accordingly, the criterion application 107a can retrieve the execution context from, for example, the computing environment 103a. The execution context can include information associated to execution of one or more processes, such as, but not limited to, processor layer information (e.g., register values), operating system layer information (e.g., information regarding one or more processes that a processor is executing, virtual memory, processor memory space, access to system resources, etc.), application layer information (e.g., application specific information about the state of a desired application, distance to a point, time to a point, etc.), higher level information (e.g., information generated and/or retrieved by an application in interaction with other entities, user references, user presence, social networks, etc.—other entities can include other applications, users, sensor information, location of user, etc.).

For the purposes of discussion, the criterion application 107a can determine one or more execution context criteria (context criteria) associated with the retrieved execution context. The criterion application 107a can secure the retrieved execution context, a representation of the retrieved execution context, portions of the retrieved execution context, or a combination thereof based, at least in part, on the determined one or more context criteria. According to certain embodiments, the criterion application 107a can divide the retrieved execution context to the one or more execution context criteria and execution content. In one example, the execution content can be secured using the determined one or more context criteria. Additionally or alternatively, the execution context (for example, include the context criteria and the execution content) can be secured using the context criteria. According to another example, the criterion application 107a can further format the execution context and/or the context criteria into predetermined information representations (such as abstraction of the execution context, the context criteria, or a combination thereof into an information structure) and perform the securing process based, at least in part, on the representation(s) (e.g., information structure(s)).

According to certain embodiments, the criterion application 107a can determine the one or more context criteria independently from the execution context. In one example, the context criteria can include state information associated with the execution context that is determined and/or combined from different sources, such as, but not limited to, low level processor specific information, operating system specific information, application specific information, higher level specific information.

The criterion application 107a, after retrieving the execution context and determining the execution context criteria (context criteria), can use the context criteria (and/or a representation of the context criteria) to secure the execution context (and/or a section of the execution context, a derivation of the execution context, a representation of the execution context). The secured execution context can be published to, for example, the information store 113, such that the computing environment 103n can access and unsecure the published secured execution context if the UE 101n, the computing environment 103n, etc., are in a desired state as presented in the context criteria. Therefore, the process of securing the execution context, according to certain embodiments, can be advantageously based on state information associated with the execution context without any knowledge of other computing environments that desire to access the secured execution context.

According to certain embodiments, the criterion application 107a can utilize cryptographic schemes, such as, but not limited to, public key cryptographic mechanism to secure the execution context based, at least in part, on the context criteria. According to one example, the criterion application 107a can use identity-based encryption (IBE), for example, in accordance with the cryptography platform 111. Accordingly, the determined one or more context criteria can be used as a key (e.g., public key) for IBE scheme.

Identity-based encryption (IBE) is a public-key technology. Conventional IBE is different from other public-key technologies in that IBE keys are calculated with unique information about the identity of the user (e.g., a user's email address), instead of being generated randomly. Identity-based systems allow any party to generate a public key from a known identity value such as an ASCII string or information in any data representation. To operate, a trusted third party, called the private key generator (PKG) first publishes a master public key, and retains a corresponding master private key. Given the master public key, any party can compute a public key corresponding to the identity ID by combining the master public key with the identity value. To obtain a corresponding private key, authorized party contacts the PKG, which uses the master private key to generate the private key for the identity ID. Since, in conventional IBE, public keys are derived from identity IDs, IBE eliminates the need for a public key distribution infrastructure. This further eliminates the need for a sender and a receiver in an IBE-based messaging system to interact with each other, before sending secure messages. The authenticity of the public keys is guaranteed as long as the transport of the private keys to the corresponding user is kept secure. IBE-encrypted messages can use standard message formats, such as the cryptographic message syntax (CMS).

According to certain embodiments, the cryptography platform 111 can operated based, at least in part, on the IBE scheme. Accordingly, the cryptography platform can include the private key generator (PKG—not shown) associated with the IBE scheme configured to generate master public key, retain master private key, authenticate request, generate private keys, etc., to control access to secure execution context encrypted based, at least in part, on the context criteria. It is noted that the determined one or more execution context criteria are advantageously used in the system 100 of FIG. 1 as and/or to generate encryption keys. Therefore, since the context criteria is used for encrypting the execution context (which can be the secret data that needs to be secured), the trusted third party (such as the cryptography platform 111) needs to have a smaller database in comparison with conventional IBE schemes.

In one example, in addition to the context criteria, the criterion application 107a can use a master public key and/or domain parameters to encrypt the execution context. According to this example, the master public key and/or the domain parameters can be retrieved from the cryptography platform 111 (e.g., the private key generator). In an embodiment, the retrieval of the master public key and/or the domain parameters can occur once, for example, at the time of manufacturing the UEs 101a-101n, subscription of the UEs 101a-101n and/or their users to a service provider, etc. In one example, the criterion application 107a can use the common parameters (common.par) (such as the mater public key, and domain parameters) and the context criteria (Criteria) to encrypt the content of the execution context (which, for example, can include criteria and content—full context=Criteria+Content) through an IBE description function enc_content=ibe_encrypt(common.par,Criteria,Content), and can publish the encrypted data (publish(enc_content) to, for example, the information store 113.

By way of example, any party (such as the computing environment 103n of UE 101n) who can meet the context criteria can choose a criteria (Criteria′) and contact the cryptography platform 111 (such as the private key generator) with the Criteria′ to obtain a decryption key. The cryptography platform 111 can verify the received criteria to determine if the requesting party meets the context criteria. If the context criteria is met, the cryptography platform 111 forward the decryption key (dec_k=ibe_get(Criteria′)) for decrypting the encrypted execution context to the requesting party (e.g., the computing environment 103n of UE 101n). According to one embodiment, the criterion application 107n of the UE 101n can retrieve the decryption key (dec_k) and the encrypted data (such as encrypted content—enc_content) and use the decryption key (alone or in accordance with common parameters) to decrypt the encrypted data. The decryption can be based, at least in part, on an IBE decryption function content=ibe_dec(common.par,dec_k,enc_c). Further, according to one example, the criterion application 107n can use the decrypted data (such as the decrypted content) and the context criteria to generate the execution context (full_context=Content+Criteria′). The computing environment 103n can use the execution context to resume the execution of one or more processes in the UE 103n (resume_execution(full_context)).

In another word, the system 100 of FIG. 1 can provide an opportunistic sharing of the execution context (and/or content). When an agent (such as the UE 101a) determined the context criteria, the content can be encrypted using the context criteria as key and the encrypted content can be pushed to, for example, a cloud (e.g., mobile cloud computing). Therefore, other agents (such as UE 101n) that have access to the cloud can opportunistically match their state to the content. If their state matches, it can be an indication that they are in a “correct” state, therefore, can continue with the execution (e.g., computation) of the execution context (after decrypting the encrypted content).

According to certain embodiments, system 100 of FIG. 1 can advantageously represent the context criteria and/or the execution context in an information representation and/or structure (e.g., a Resource Description Framework (RDF graph)). For example, the criterion application 107a, after retrieving execution context and determining the context criteria, can format the execution context, the context criteria, or a combination thereof in the information representation and/or structure, use the information representation and/or structure (e.g., the RDF graph) to encrypt the execution context (or its representation), and publish the encrypted data to, for example, the information store 113. The cryptography platform 111 (such as the private key generator (PKG)) then verifies authorized parties as discussed above (e.g., verifies that the authorized parties meet the context criteria). To simplify the discussion, RDF graphs are used as one example of representation of the context criteria. In one embodiment, RDF graphs represent decision diagrams and describe resources with classes, properties, and values. A node/resource is any object which can be pointed to by a uniform resource identifier (URI), properties are attributes of the node, and values can be either atomic values for the attribute, or other nodes. RDF Schema provides a framework to describe application-specific classes and properties. Classes in RDF Schema are like classes in object oriented programming languages. This allows resources to be defined as instances of classes, and subclasses of classes.

The RDF graphs are represented or encoded in decision diagrams which describe the properties and relations of different classes. A class has a name and potentially several associated properties, and it may be a subclass of another class. Possible properties are represented as arcs from one class node to other class nodes. These property-arcs can be properties of the object which have values (that are the nodes targeted by the property arcs). Each RDF-graph includes a set of unique triples in a form of subject, predicate, and object, which allow expressing graphs. The simplest RDF-graph is a single triple. Any node or entity can store unconnected graphs. As later explained in more detail, the approach described herein can be adapted in a smart space that includes the semantic web and has distributed nodes and entities that communicate RDF-graphs (e.g., via a blackboard or a shared memory).

To further reduce the size of the context criterion representation, the system 100 can use, for instance, a subset of the RDF graph to represent the recipient criteria. By way of example, a compact representation of the RDF graph in the form of a reduced ordered binary decision diagram (ROBDD) is used as a subset of the RDF graph. In another embodiment, instead of the ROBDD, an augmented ROBDD (“AugBDD”) including a hash identifier is employed to further reduce the size of recipient criterion representation. As the size of the context criterion representation is further reduced, the storage required for the context criterion representation is also reduced. More specifically, the system 100 can provide for hash tables listing known or existing RDF graphs along with their corresponding respective ROBDDs, hash identifiers and other related information. A user may then consult one of the hash tables to obtain a corresponding decision diagram with a hash identifier.

One consideration for selecting the RDF graph encoding scheme is that the encoding scheme should generate a hash identifier for a decision diagram with a reasonably small size while maintaining uniqueness of the hash identifier such that any two decision diagrams will not have identical hash identifiers. For example, upon receiving a search query, the system 100 serializes the decision diagram into variables and then feeds the variables into a hash function thereby obtaining unique hash identifiers corresponding to the decision diagram. In addition, the system 100 can truncate the hash identifiers to a specific bit size while maintaining their uniqueness, thereby saving communication resources (e.g., reducing network bandwidth) while transmitting the same information.

In other words, to address the problem of the traditional public encryption systems, a system 100 of FIG. 1 introduces the capability to apply context criteria in identity-based encryption. The RDF graphs of context criteria are encoded to decision diagrams to be communicated between the nodes (e.g., the UEs 101a-101n) and entities (not shown). To further reduce communication traffic, the system 100 encodes (e.g., hashes) the decision diagrams of the recipient criteria into hash IDs, and avoids sending decision diagrams of the recipient criteria by sending the hash IDs (and optionally a construction history of the decision diagrams). The reduced ordered binary decision diagram (ROBDD) is used as an efficient representation for a binary decision diagram representing the context criteria and hashed with a hash function into a hash identifier (hash ID).

As used herein, the term “decision diagram” refers to a compact graphical and/or mathematical representation of a decision situation, sets, or relations. A decision diagram, for example, may be a binary decision diagram (BDD) or a reduced ordered binary decision diagram (ROBDD). A BDD is “ordered” if different variables appear in the same order on all paths from the root. A BDD is “reduced” if any isomorphic subgraphs of its graph are merged and any nodes whose two child nodes are isomorphic are eliminated. Isomorphic subgraphs of the same decision diagram have similar appearance but originate from different sources. A ROBDD is a group of Boolean variables in a specific order and a directed acyclic graph over the variables. A directed acyclic graph (DAG) contains no cycles. This means that if there is a route from node A to node B then there is no way back. Although the term BDD almost always refers to reduced ordered binary decision diagram (ROBDD), this application refers to ROBDD separately from BDD to avoid confusion.

A decision diagram may be used to organize any data, including one or more recipient criteria, into a tree-type data structure that permits identification of a result by traversing various branches of the structure. Although various embodiments are described with respect to applying context criteria, it is contemplated that the approach described herein may be used with other data that can be organized into a tree-type data structure. The term “AugBDD” refers to an augmented ROBDD which is augmented information including the ROBDD and at least one of a header with a hash identifier (“hash ID”), a construction history of the ROBDD, keyed hash IDs, and cardinality information (e.g., relationships between data tables, constraints on the types and number of class instances a property may connect with respect to a given ontology, etc.). Each ROBDD is given a hash ID by operating a hash function over its ROBDD graph structure. Ideally, the hash function would never produce the same hash ID for two different ROBDDs.

As used herein, the term “construction history information” of a hash identifier of interest includes at least one or more other hash identifiers corresponding to a respective one or more other decision diagrams used to construct a decision diagram corresponding to the hash identifier of interest. The construction history also includes identification of one or more Boolean operators applied to the other hash identifiers listed in history. Since the ROBDD may be constructed by BDD operations from other ROBDDs, a succinct representation of the ROBDD including the construction history of the ROBDD and a hash ID can be sent instead of the ROBDD, to reduce data traffic. In one embodiment, plain hash IDs form the basis for the communication. A keyed hash ID may be added in the communication along with a key ID. This allows the recipient to ensure that the keyed hash ID can be created from the corresponding graph (or the plain hash ID) by using the produced key. To create a keyed hash ID, the data of the ROBDD is serialized to be input into a keyed hash function, such as HMAC-SHA1, HMAC-SHA-256, etc. The keyed hash function allows entities to share the same secret key and to independently ensure that the resulting hash IDs were created by an entity having the secret key. Key IDs may correspond to different groups, such as different social networks. A key ID together with an ROBDD graph constitute proof that the ROBDD has been constructed by the owner of the key ID.

By way of example, the communication network 109 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 101a-101n can be any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UEs 101a-101n can support any type of interface to the user (such as “wearable” circuitry, etc.).

By way of example, the UEs 101a-101n, the cryptography platform 111, and the information store 113 communicate with each other and other components of the communication network 109 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

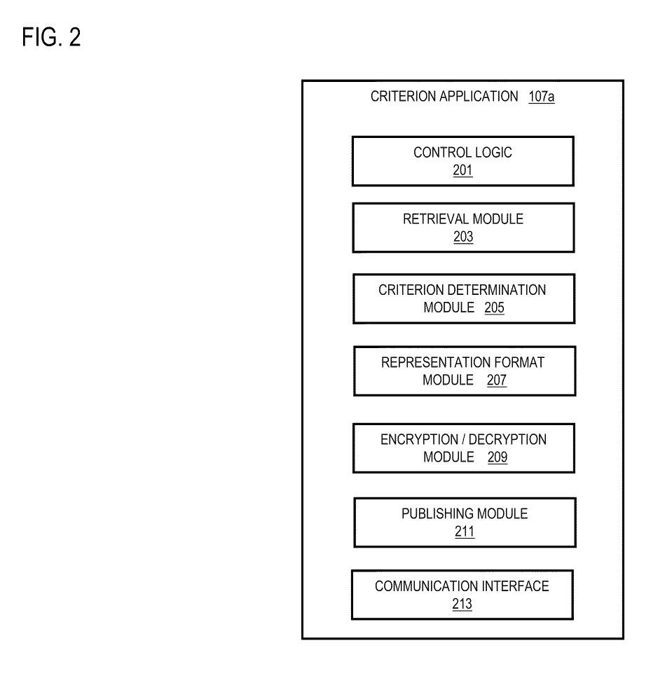

FIG. 2 is a diagram of the components of a criterion application, according to one embodiment. By way of example, the criterion application 107a can include one or more components for applying execution context criteria for secure execution context sharing. It is contemplated that the functions of these components may be combined in one or more components or performed by other components of equivalent functionality. In this embodiment, the criterion application 107a can include at least a control logic 201 (such as at least one processor or other control logic) for executing at least one algorithm for performing the functions of the criterion application 117a.

According to an exemplary embodiment, the criterion application 117a, which can be located at the UE 101a of FIG. 1, can receive a request, for example, using a communication interface 213 to retrieve the execution context associated with, for example, the computing environment 103a of FIG. 1, determine one or more execution context criteria associated with the execution context, encrypt the execution context, and publish the encrypted execution context. According to one example, the request for encryption can be received by the communication interface 213 and can be initiated by one or more of the UEs 101a-101n, one or more users of the UEs, one or more of the computing environment 103a-103n, etc. The retrieval module 203 in accordance with, for example, the control logic 201 can receive a request for retrieval of an execution context and can retrieve the requested execution context from, for example, the computing environment 103a.

The criterion determination module 205 can determine one or more context criteria associated with the retrieved context. According to one example, the criterion determination module 205 can determine the context criteria by selecting the criteria from the execution context. In this example, the criterion determination module 205 can divide the execution context to the context criteria and content to be encrypted using, at least, the context criteria. Additionally or alternatively, the criterion determination module 205 can derive the context criteria from the execution context. According to another example, the context criteria can be determined based, at least in part, on the execution context. As discussed before, the context criteria can be selected independently and can define rule and terms that need to be met in order to decrypt the encrypted execution context. According to certain embodiments, the context criteria can include, at least in part, state information associated with the execution context. For example, the criterion determination module 205 can select one or more layers of the execution context and retrieve (for example, in accordance with retrieval module 203) state information from the one or more selected layers. According to one embodiment, the criterion determination module 205 can determine a level of granularity for the context criteria and can determine the selection of the layers of the execution context based, at least in part, on the determined level of granularity. Therefore, advantageously applying granular user context in the computing environment migration. As discussed before, the context criteria can include state information associated with the processor layer, for example, containing information about register values; operating system layer, for example, containing information about processes that one or more processors are executing; application layer, for example, containing application specific information about the state of a desired application; high-level layer context information, which, for example, one or more applications can get by interacting with other entities. The other entities can include other applications, users, sensor information, location of a user, etc. Alternatively or additionally, the context criteria can include processor and/or memory state (for example, associated with the computing environment 103a) such as, but not limited to, registers and/or certain memory areas; technical requirements (for example, digital right management (DRM) compliant); application preference; content preference; enforced conditions (e.g., enforced by a user, a server, a device); a sensed physical value (e.g., location, temperature, etc.), or any combination thereof.

Further, the encryption/decryption module 209 can use the determined one or more context criteria (determined by the criterion determination module 205) to encrypt the execution context. According to one example, the encryption/decryption module 209 can use the determined context criteria as the public key of the IBE scheme for encrypting the execution context. Additionally or alternatively, the encryption/decryption module 209 can a master public key and/or domain parameters in encrypting the execution context. In one example the master public key and/or domain parameters are determined and are communicated to the UE 101a once (for example, at manufacturing of the UE 101a, registration of the UE 101a by a service provider, etc.) and are used by the encryption/decryption module 209 for encrypting the execution context, before the encrypted execution context is published to the information store 113 of FIG. 1. According to certain embodiments, the encryption and/or decryption processes performed by the encryption/decryption module 209 can be in accordance with the cryptography platform 111 of FIG. 1. The encrypted execution context can be published by, for example, the publishing module 211 to the information store 113 of FIG. 1.

Moreover, the encryption/decryption module 209 can be configured to decrypt encrypted execution context based, at least in part, on meeting the context criteria set for the encrypted execution context. According to certain embodiments, the criterion application 107a can desire to access to an encrypted execution context stored in, for example, the information store 113 of FIG. 1, in order for the computing environment 103a to continue the execution of the execution context, which has been, for example, started in another computing environment. According to this example, the criterion determination module 205 in accordance to, for example, the communication interface 213, can present a set of context criteria to, for example, the cryptography platform 111 of FIG. 1, for access to an encrypted execution context. If the cryptography platform 111 determines that the received context criteria satisfies the context criteria associated with the encrypted execution context, the cryptography platform 111 can initiate communication of the encrypted execution context from, for example, the information store 113 to the encryption/decryption module 209. Additionally or alternatively, the cryptography platform 111 can initiate transmission of one or more decryption keys to the encryption/decryption module 209 based on the received and verified context criteria. The encryption/decryption module 209 can use the one or more decryption keys to decrypted the encrypted execution context (and/or a portion of the execution context). The decrypted execution context can be communicated to the computing environment 103a to continue execution of the execution context in the UE 103a. According to an example, the decrypted content can be a portion of the execution context and the encryption/decryption module 209 can determine the full execution context using the decrypted content and the determined criteria.

According to certain embodiments, the criterion application 107a can include the representation format module 207 configured to initiate abstraction of the execution context, the context criteria, or a combination therefore, into an information structure. In this example, the encryption/decryption module 209 can use the abstraction for encryption/decryption purposes. According to certain embodiments the representation format module 207 can construct a RDF graph from one or more context criteria, a ROBDD from the RDF graph, a hash identifier of the ROBDD, and a keyed hash identifier of the ROBDD. The representation format module 207 can also construct a RDF graph from secret data (e.g., execution context), a ROBDD from the RDF graph, a hash identifier of the ROBDD, and a keyed hash identifier of the ROBDD. Therefore, the encryption/decryption module 209 can also encrypt the execution context (and/or the representation of the execution context) using one of the ROBDD, hash identifier, or keyed hash identifier of the context criteria as a public key, and decrypting the encrypted secret data (e.g., execution context) with a decryption key. The use of RDF graphs can advantageously provide high abstraction level.

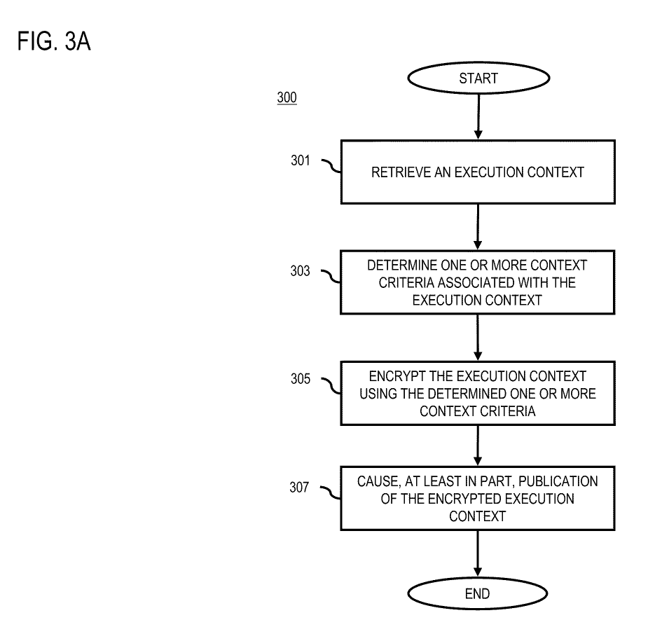

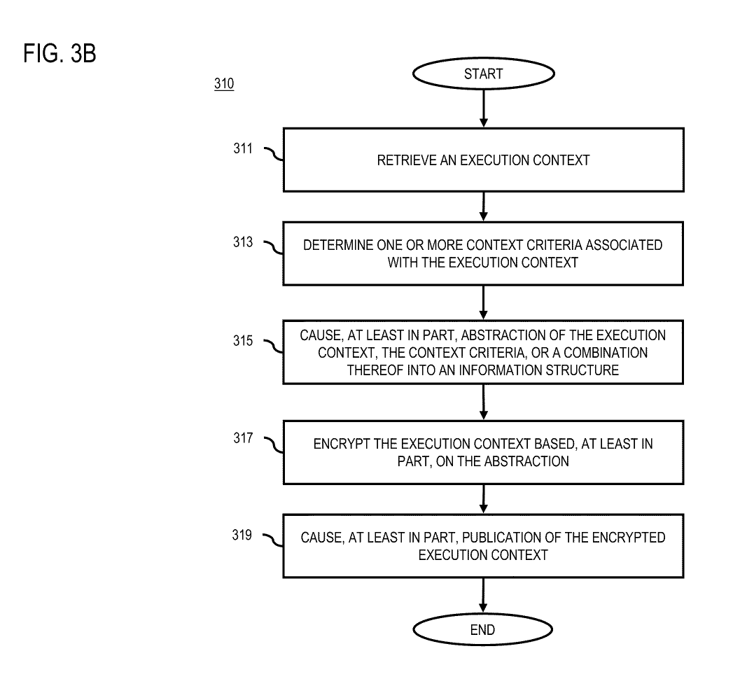

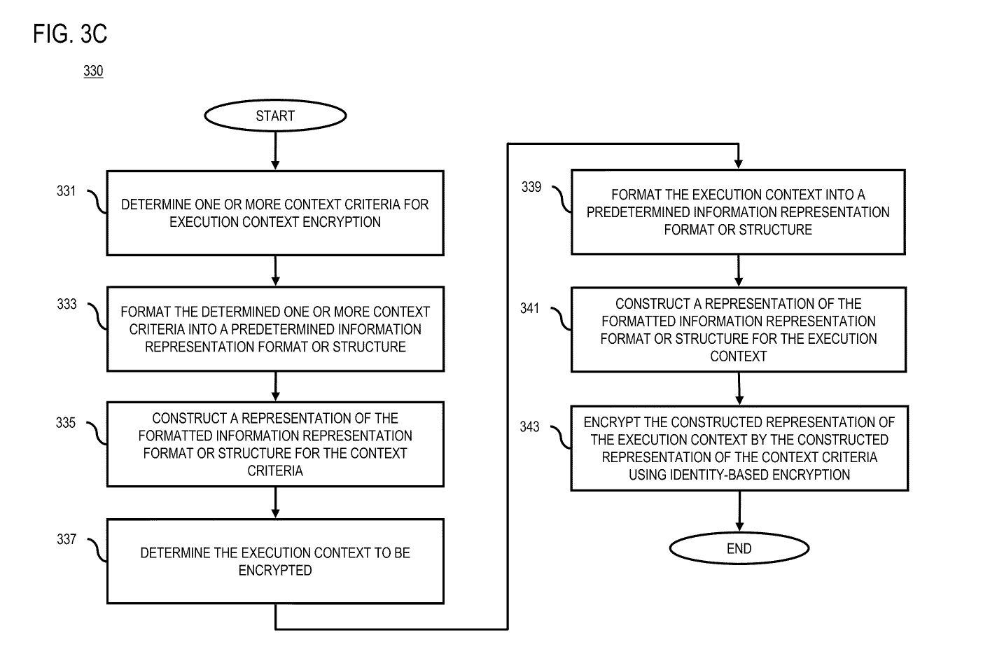

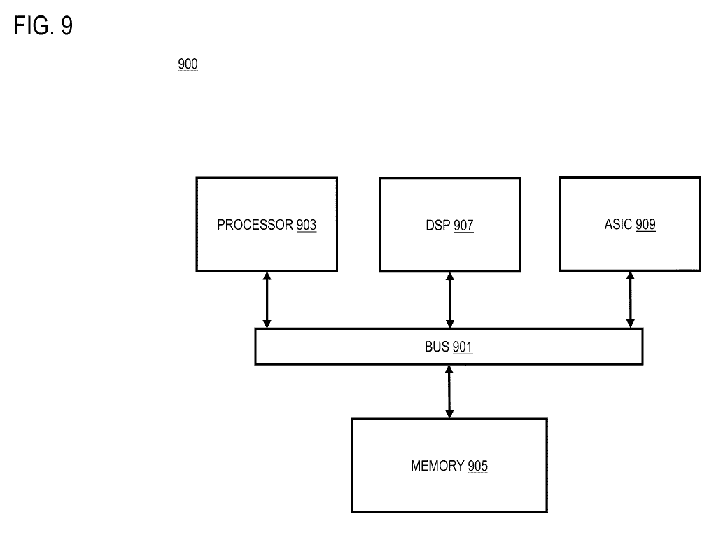

FIGS. 3A-3C are flowcharts of processes for applying execution context criteria for secure execution context sharing, according to various embodiments. In one embodiment, the criterion application 107a-10n can perform the processes 300, 310, and/or 330 and is implemented in, for instance, a chip set including a processor and a memory as shown in FIG. 9.

In step 301 of process 300, an execution context is retrieved. A portion of execution context, a representation of the execution context, or the entire execution context is sought to be encrypted. According to certain embodiments, the execution context can be retrieved from the computing environment 103a-103n of FIG. 1. In step 303, one or more context criteria associated with the execution context is determined. In on example, the context criteria can include state information associated with the execution context. Alternatively or additionally, the process of determining the one or more context criteria can include selection one or more layer of the execution context and retrieving the state information based, at least in part, on the one or more selected layers. Also, step 303 can further include determining a granularity for the context criteria such that layers of the execution context is selected based, at least in part, on the level of granularity.

Based, at least in part, on the determined context criteria, the execution context is encrypted per step 305. According to certain embodiments, the encryption of the execution context can be based, at least in part, on the identity-based encryption (IBE) scheme, and the determined one or more context criteria can be used as public key. As discussed earlier, a master public key and/or domain parameters can also be used in the encryption process. At step 307, the encrypted execution context is published. The encrypted execution context can be published to, for example, the information store 113 of FIG. 1, such that other execution environments that desire to continue execution of the execution context and possess the desired context criteria can access the encrypted execution context.

Process 310 of FIG. 3B illustrates another embodiment of applying execution context criteria for secure execution context sharing. In the exemplary process 310, the execution context is retrieved per step 311 and one or more context criteria associated with the execution context is determined per step 313. In step 315, the abstraction of the execution context, the context criteria, or a combination thereof into an information structure is initiated, as explained in more detail with respect to process 340 of FIG. 3C. In step 317, the execution context and/or the information structure derived from the execution context is encrypted using the context criteria and/or the information representation of the context criteria. In step 319, the encrypted execution context is published to, for example, the information store 113 of FIG. 1.

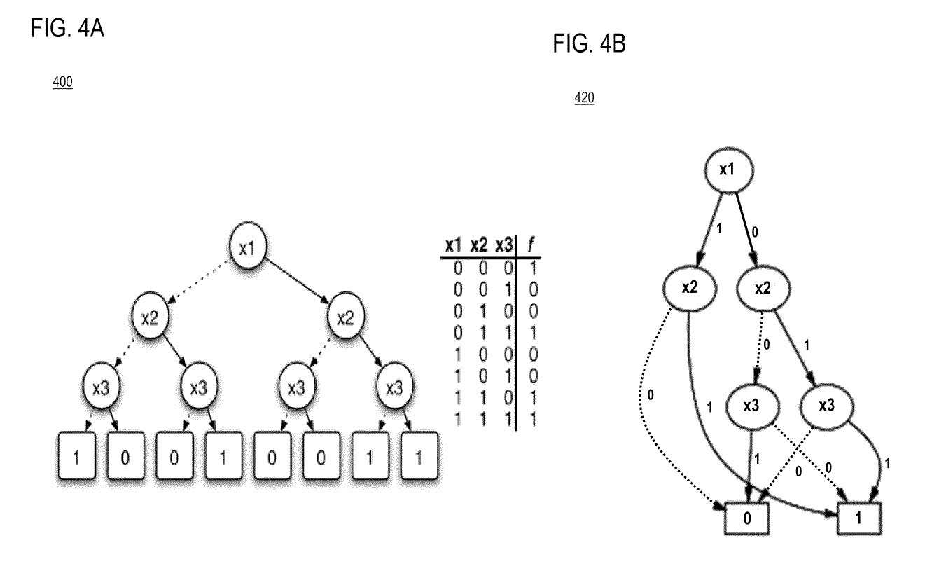

Process 340 of FIG. 3C illustrates another embodiment of applying execution context criteria for secure execution context sharing where representation of execution context and/or context criteria are used for encryption purposes. According to one example, at step 331, one or more context criteria associated with the execution context are determined that can be used in encrypting the execution context. At step 333, the determined one or more context criteria are formatted into a predetermined information representation format or structure. According to certain embodiments, the process 340 can be explained in more details with respect to the RDF graph 400 of FIG. 4A and ROBDD 420 of FIG. 4B representing the context criteria and/or execution context. In this example, at step 333, the context criteria are formatted to the predetermined information representation format or structure, e.g., the RDF graph 400 of FIG. 4A. At step 335, a representation of the formatted information representation format or structure for the context criteria is constructed. According to certain embodiments, the constructed representation of step 335 can include a reduce ordered binary decision diagram (ROBDD), such as the ROBDD 420 of FIG. 4B, for the context criteria. In one example, the RDF graph 400 of FIG. 4A can be serialized into variables of predetermined format to construct the ROBDD 420 of FIG. 4B. There are many ways or conditions for encoding the RDF graph 400 into bit vectors. For instance, the different bit sizes can be used as discussed below. Different bit sizes result in, for instance, different numbers of variables which lead to ROBDD graphs of different sizes and shapes. ROBDD is essentially a group of Boolean variables in a specific order and a directed acyclic graph over the variables. In one example, different BDD variables can be set representing different criteria for the context criteria. Then a number of bits for representing and encoding the context criteria can be set. Accordingly, these variable can be encoded and saved in, for example a dictionary. Further, a ROBDD 420 from the variables can be constructed.

In one example, at step 337, the execution context that is to be encrypted is determined. According to certain embodiments, the process 330 can skip steeps 339 and 341 and therefore, can encrypt the execution context based, at least in part, on the ROBDD 420 of the execution context as the public key, per step 343. Accordingly, the process 330 can further publish the encrypted execution context (not shown) and/or cause, at least in part, storage of the ROBDD 420 of the context criteria (not shown). Since the ROBDD 420 is smaller than the RDF graph 400, the system 100 of FIG. 1 can advantageously reduce storage needs and network traffic for the system.

In addition to or in alternative to encrypting the execution context using the ROBDD 420, the process 330 can compute a hash identifier corresponding to the ROBDD 420 of the context criteria (not shown), thereby encrypting the execution context using the has identifier of the context criteria as the public key (per step 343). Additionally, the process 330 can further cause, at least in part, storage of the hash identifier of the context criteria (not shown) which can further reduce storage needs and network traffic with respect to the ROBDD 420.

To compute the hash identifier of the ROBDD 420, a hash function for obtaining unique hash identifiers within the system 100 can be selected, and the representation is fed into the hash function. Like the size of the bit encoding, the hash function is usually chosen heuristically or to be adhered to by all users and/or components of the system 100. Optionally, the computed hash identifier can be shortened by truncating a result of the hash function while obtaining unique hash identifiers. The hash identifier can also be stored with the ROBDD 420, before publishing the hash identifier of the context criteria.

According to certain embodiments, the hash identifier of the context criteria can also be encrypted with a key to generate a keyed hash identifier of the context criteria and the keyed hash identifier can be further stored. Since the keyed hash identifier is more secured than the hash identifier, this embodiment provides a means for further securing the recipient criteria related information. To obtain the ROBDD 420 or the RDF 400 from the hash identifier or the keyed hash identifier, the information store 113 and/or the intended recipients may compare incoming derivative of the potential recipient criteria with the derivatives in a database to identify the corresponding ROBDD 420 or RDF 400. Alternatively, the intended recipients may reconstruct the ROBDD 420 or RDF 400 via a reverse computation in conjunction with the construction history of the ROBDD 420 or RDF 400 in the database. When the derivative of the recipient criteria is a keyed hash identifier, the key used to encrypt the hash identifier is identified by the key ID, and then used to decrypt the keyed hash identifier.

According to certain embodiments, the process 330 can also format the execution context into a predetermined information representation format or structure and/or construct a representation based, at least in part, on the predetermined format or structure. This can be in addition to or in alternate with respect to formatting the context criteria into a predetermined information representation format or structure and/or construct a representation based, at least in part, on the predetermined format or structure. In this example, at step 339, the execution context can be formatted into a predetermined information format or structure. In one embodiment, the formatting process can include formatting the execution context into an RDF graph. Additionally, alternatively, or optionally, a representation of the predetermined information format or structure can be constructed for the execution context in step 341. According to one example, this construction process can include constructing another ROBDD from the RDF of the execution context.

In one embodiment, the RDF graph and/or the ROBDD of the execution context can be encrypted using either the context criteria, the RDF of the context criteria, the ROBDD of the context criteria, the hash identifier of the context criteria, or a combination thereof, per step 343. The encrypted execution context can further be published, for example, to the information store 113 of FIG. 1. In another embodiment, a hash identifier corresponding to the ROBDD of the execution context can be computed, thereby encrypting the hash identifier of the execution context using the context criteria, the RDF of the context criteria, the ROBDD of the context criteria, the hash identifier of the context criteria, or a combination thereof as the public key (not shown). The encrypted hash identifier of the execution context can be published.

Optionally, the encrypted hash identifier of the execution context can be further encrypted with a key, to provide one additional layer of protection. The encrypted ROBDD, hash identifier, or keyed hash identifier of the execution context can be published in the semantic web with the hash identifier or keyed hash identifier of the context criteria that is used to encrypt the encrypted decision diagram, hash identifier, or keyed hash identifier of the secret data. The above-discussed sets of keys, key IDs, and the encrypted targets can be stored at the cryptography platform 111, the UEs 101a-101n, the information store 113 for marching the corroding ROBDDs or RDF graphs without transmitting them over the communication network 109. In addition, if these entities also store the construction histories of the ROBDDs or RDF graphs, they can reconstruct a ROBDD or RDF graph locally based on a hash identifier or a keyed hash identifier, when the ROBDD or RDF graph is not stored locally.

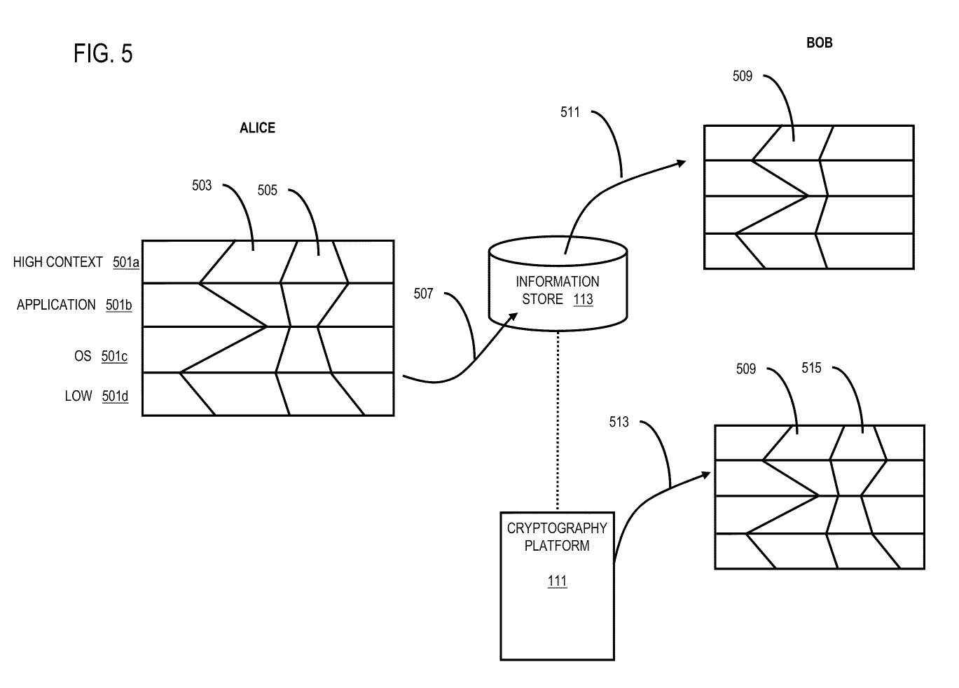

FIG. 5 is a utilization diagram of the process for applying execution context criteria for secure execution context sharing, according to one embodiment. Considering a situation shown in FIG. 5, a user (e.g., Alice) desires to share an execution context with another participant (e.g., Bob) in, for example, the system 100 of FIG. 1, using one or more context criteria. In one example, Alice and Bob have started execution of an application (e.g., a game) on UE associated with Alice. Further, they want to continue the execution of the application on another UE associated with Bob. According to this example, the execution context associated with the execution of the game is encrypted based on one or more context criteria determined by, for example, Alice, associated with the execution context. The encrypted execution context can be published at the information store so it can be access by Bob, if desired context criteria is presented and verified. According to this example, the execution context can include the context criteria 503 and the content 505 including state information associated with the execution context retrieved from one or more layers of the execution context. In the example of FIG. 5, the execution context (which includes criteria 503 and content 505) can include state information associated to high context level 501a, application level 501b, operating system 501c, lower level (e.g., processor and/or memory level) 501d.

By way of example, Alice can determine the one or more conditions used to determine the one or more context criteria 503 to be used for encryption of the content 505. An exemplary set of context criteria 505 is shown in Table 1:

TABLE 1

| :c | |
|---|---|
| :game “Chess” | # Application context |
| :player “Alice” | # high context |
| :player “Bob” | # high context |
| :exe_name “chess.exe” | # OS context |
| :architecture “ARM-9” | # Processor and memory context |
| :OS “maemo-linux 1.5” | # OS context |
| :number_of_moves “21” | # Application context |

The criterion application of the UE of Alice (for example, criterion application 103a) uses the determined context criteria (for example Table 1), the master public key, domain parameters, or a combination thereof to encrypt the content 505 and can publish the encrypted content, per 507, to the information store 113, which in turn, relays the encrypted content to the UE of Bob, per 511. According to another embodiments, criterion application 103a can construct an RDF graph containing the context criteria, can convert the RDF graph into a ROBDD, and can compute a AugBDD hash identifier for the ROBDD via C_ID=AugBDD(:c). The hash identifier can be used for encryption purposes. Alice can also determine the secret data, e.g., content 505 that needs encryption. In one example, the secret data is shown in Table 2:

TABLE 2

| :s | |
|---|---|
| :memory_start “0x01AG” | # Processor level . . . |
| :memory_end “0xFFAA” | |
| :memory “0xACDC43210 . . . ” | # truncated |
| :chess_tileset “3d-pieces” | # application level |

According to certain embodiments, the secret data can be converted into a ROBDD and a hash identifier can be generated via S_ID=AugBDD(:s). A set of IBE common domain parameters (e.g., common_pars) as discussed can be obtained from, for example, the cryptography platform 111. The hash identifier of the secret data can be the encrypted using, for example, the hash identifier of the context criteria and the common parameters as Msg=IBE_crypt(common_pars,C_ID,S_ID).

The encrypted content encrypted using the context criteria 503 is published in the information store 113. A participant that could present the desired criteria can access the encrypted content, gain access to the decryption key, and decrypt the encrypted content. Accordingly, the participant Bob determines a set of context criteria 509 and presents the criteria 509 to the cryptography platform 111. In one example, the cryptography platform 111 can verify the criteria 509 and compare them to the criteria 503. If the criteria are met, the cryptography platform 111 can initiate transmission of a decryption key to the UE of Bob per 513. The Bob's UE can use the received decryption key, the common parameters, the encrypted content, or a combination thereof to decrypt the encrypted secret data to get the content. The criteria 509 and the derived content 515 are combined to derive the execution context to be executed on the UE associated with Bob.

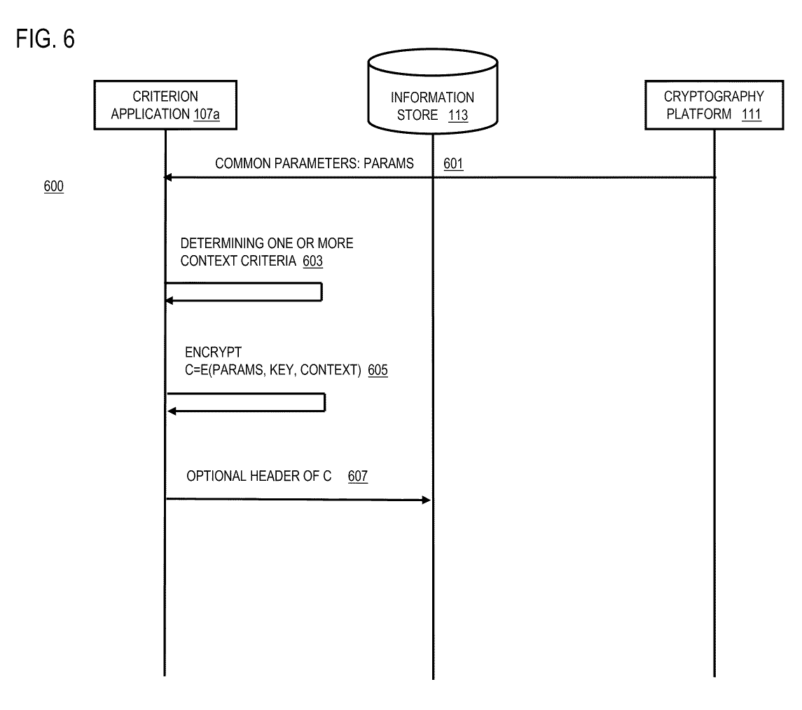

FIG. 6 is an operational diagram for content encryption using execution context criteria, according to one embodiment. In step 601, the cryptography platform 111 can transmit IBE common parameters to the criterion application 107a. In one example, this operation is typically performed ones, for instance, when a user and/or UE registers with a service of a service provider; a UE is manufactured; etc. The IBE common parameters can be used in accordance with determined context criteria for encryption of the execution context. Accordingly, at process 603, the criterion application 107a determines one or more context criteria associated with the execution context to be encrypted. The determined one or more context criteria can be used, for example, as public key in the IBE scheme. The execution context (and/or a portion of, representation of, etc.) is further encrypted using the common parameters, the key, or a combination thereof by process 605. The encrypted execution context is optionally published to the information store 113 at 607.

The optional message 607 sent to the information store 113 can include the context criteria and/or a header. For example, the message can be an email, SMS, EMS, MMS, etc.; and the header can describe or otherwise specify the context criteria. When the context criteria are sent in a message without a header, the information store 113 or any intended recipient can read the context criteria transmitted through a logically separate message. The separate message makes the context criteria visible, i.e., not being encrypted. On the other hand, if the context criteria are not described in the header or transmitted through the separate message, the intended recipient, that meets the specified criteria and/or has a corresponding decryption key given by the information store 113, cannot determine whether to decrypt the published encrypted secret data before trying to decrypt the encrypted secret data.

When the message is sent with a header containing the context criteria, the information store 113 can take action based upon the header without reading the message body. Further, if the information store 113 can make the header available for everyone, the intended recipient can determine whether to decrypt the encrypted secret data before trying to decrypt the encrypted secret data. It is noted that under some conditions, although non-intended recipients (e.g., as other nodes) may have no key to open up or decrypt the published encrypted secret data, the non-intended recipients may nonetheless use the context criteria described in the header to generate other encrypted secret data (e.g., spam, etc.) targeted at the group of intended recipients. When the criterion application 107a is concerned about such spam attacks or other unwanted information resulting from the context criteria described in the header, the criterion application 107a can still include the header in the message while requesting that information store 113 not to publish the context criteria.

According to certain embodiments, the header can also include a hash and/or keyed hash of the context criteria. In this example, using hashes can prevent the above spamming problem and can aloe information store 113 to publish the headers. However, the query can be more complex, since the entity may need to compute the derivative from potential criteria and compare the derivatives. Additionally or alternatively, if key hash is used, then nodes (such as users, UEs, applications, entities, etc.) with the proper key for the keyed hash may encrypt.

As described, the above-described embodiments independently encrypts without collaboration, input, or creating any direct relationships to the intended recipients. Instead, the encryption is based on context criteria defining criteria associated with execution context without specifically identifying the recipients.

In an additional or alternative implementation, the above-described embodiments can be utilized as part of smart space structure. In one exemplary embodiment, the M3 smart space structure can be implemented, which can provide availability to all locations in the functionally architecture. In one example, the M3 smart space structure can offer a functional architecture that can provide, for example, cross domain search extent for information resulting in enormous opportunities in application development.

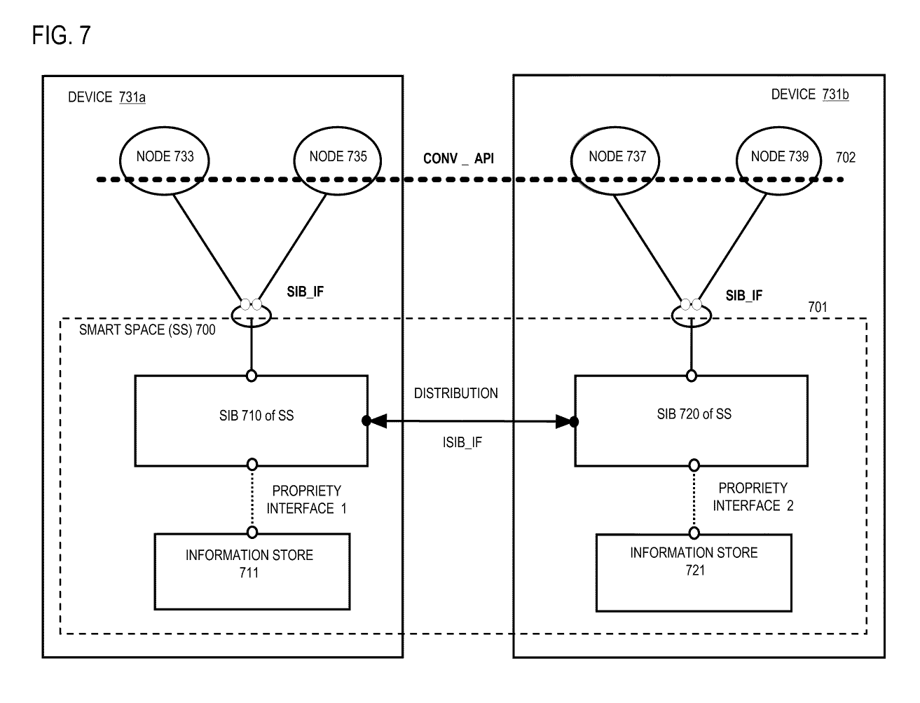

FIG. 7 is a diagram of a smart space structure for of applying execution context criteria for secure execution context sharing, according to one embodiment. Each smart space 700 includes smart space nodes/objects 733, 735, 737, and 739 and semantic information brokers (SIB) 710, 720 which form the nucleus of the smart space 700. Each SIB is an entity performing triple governance in possible co-operation with other SIBs for one smart space. A SIB may be a concrete or virtual entity. Each SIB also supports the smart space nodes/objects 733, 735, 737, and 739 (e.g., a user, a mobile terminal, or a PC) interacting with other SIBs through information transaction operations required by the system 100, such as accessing various information records for data mining thereby out-reaching the targeted recipients. Any participants of the system 100 can also post their execution and/or context information at any node or information stores to make the information available for the system 100 to match with different sets of context criteria.

From the perspective of the recipients, they do not have to sign-up with any commercial, professional, or social network website in order to receive the above-described messages. Any information the recipients ever provide to a public and/or private entity in the real world or in the virtual world can be incorporated into the smart space as granted by the recipients/participants. The entity can be a real world legal entity or a virtual entity (e.g., an avatar). For example, the information records include the government records (e.g., birth certificates, school records, driver's licenses, tax records, real property records, criminal records, etc.), commercial activity records (e.g., flight tickets, movie tickets, CD/DVD/book purchases, restaurant/store/hospital/gym visits, car/house/education loans, credit debts, phone/utility/heating bills, internet browsing behaviors, etc.), personal activity records (e.g., basketball teams, hikes, etc.). The system 100 data-mines the information records to uncover patterns of the recipients in data either with or without their real-world identification. When the system 100 is allowed by the recipients only to data-mine without associating the information with their real-world identification, the system 100 can associate the data mining results with a reference that may be tied to an alias of the recipient such that the system 100 can send messages to the recipient later. The above-described embodiments reach the recipients over a secure, encrypted mechanism to ensure total confidentiality. The system 100 protect the privacy and confidentiality of the recipients by eliminate the sender's need to know the recipient identification (e.g., names, email addresses, etc.). The system 100 uses the information regarding the messages and the corresponding recipients with authorization of the senders and the recipients.

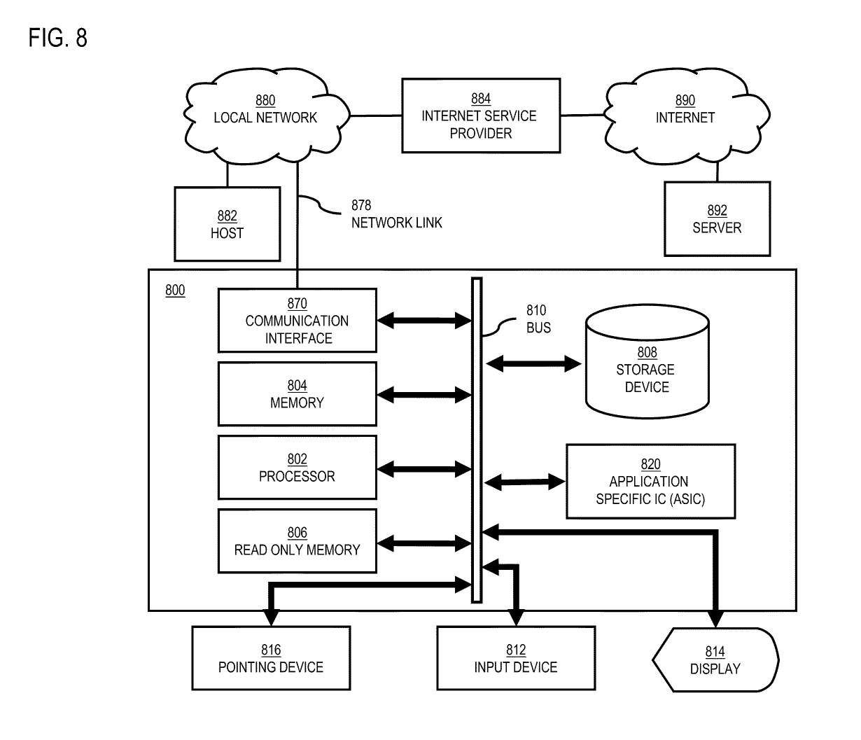

The devices 731a, 731b may be any devices (e.g., a mobile terminal, a personal computer, etc.) or equipment (e.g., a server, a router, etc.). By way of example, RDF can be used in the smart space 700. The triple governance transactions in the smart space 700 uses a smart space Access Protocol (SSAP) to, e.g., join, leave, insert, remove, update, query, subscribe, unsubscribe information (e.g., in a unit of a triple). A subscription is a special query that is used to trigger reactions to persistent queries for information. Persistent queries are particular cases of plain queries. The physical distribution protocol of a smart space (i.e., SSAP) allows formation of a smart space using multiple SIBs. With transactional operations, a node/object produces/inserts and consumes/queries information in the smart space 700. As distributed SIBs belong to the same smart space 700, query and subscription operations cover the whole information extent of a smart space. According to an embodiment the SSAP endpoint can be implemented as part of the computer system 800 of FIG. 8, for example, on top of communication interface 870 of FIG. 8 and/or as an extension of the internal bus 810 of FIG. 8.

FIG. 7 also shows an implementation structure of the system 100 in the smart space (SS) 700, the smart space 700 is depicted in the box in a broken line 701 (as the boundary of the smart space). There are two devices 731a and 731b connected to the smart space. In the upper part of FIG. 7, a dotted line 702 illustrates the boundaries of the devices. The devices can be mobile terminals, personal computers, servers, or the like. Each device can include nodes (e.g., two) therein. Each node represents a knowledge processor (KP). KPs are entities contributing to inserting and removing contents as well as querying and subscribing content according to ontology relevant to its defined functionality. A KP needs one or more partner KPs for sharing content and for implementing an agreed semantics for the used ontology. With this implementation structure, the smart space 700 serves private and public entities in different domains A and B using the devices 731a and 731b and KPs running in the domains A, in order to support the private and public entities to access information services and the system 100. According to certain embodiments, the KPs may require memory (such as memory 804 of FIG. 8) and/or processor (such as processor 802 of FIG. 8) resources in addition to using communication mechanism (such as 870 of FIG. 8). Also, the may use a storage device (such as 808 of FIG. 8) and/or read only memory (such as 806 of FIG. 8).

In this embodiment, the internal and external AugBDD tables are embedded in the SSAP protocol at SIB_IF or ISIB_IF upon an “insert” protocol message. The system 100 builds itself on top of the smart space protocol, to use ontological constructs for processing RDF graphs, ROBDDs, hash identifiers for the recipient criteria and the secret data. The SIB_IF is an interface between the SIBs and a device, and the ISIB_IF is an interface between two SIBs.

In one embodiment, the approach described herein is implemented at the interfaces SIB_IF and ISIB_IF of the system 100 to transmit the hash IDs and the encrypted execution context packets. In other embodiments, one or more application programming interfaces (APIs) (e.g., third party APIs) can be used in addition to or instead of SIB_IF and ISIB_IF. The approach described herein provides performance gains while allowing multiple proprietary implementations of information stores in the smart space 700 according to FIG. 7. The decoding complexity for developing an application is buried below a convenience API (CONV_API) according to FIG. 7. Similarly, the tools for a local (at the node level) information search are provided as a part of a convenience library.

As discussed, the augmentation of construction history and other information related to the ROBDD of the context criteria and the execution context can be embedded in the corresponding AugBDDs. In one embodiment, the smart space protocol messages are checked for hash ID consistency by (1) checking for the correct (according to ontology) types of hash IDs in term of a range and a domain of the instances that have a defined property between them, and (2) checking for a correct number of hash IDs connected by the defined properties. In other words, the (1) and (2) mechanisms are applied to detect the smart_space_robdd_id concept within the smart space messages and then perform the checking for the availability of hash IDs from the external index table. The request for a missing hash ID can then be executed via a smart space query. This query relies upon the ROBDD graphs being available in a SIB in the smart space. The AugBDDs can be sent over to a remote system that uses the AugBDDs locally to check the consistency of the hash IDs or other properties in local information stores, which allows checking for ontology conformance without direct access to the ontology description.

One of the problems of sharing information in the semantic web is to share the graphs or parts of the graphs (i.e., subgraphs) among distributed nodes and entities via information stores with sufficient identification of the graphs (especially the subgraphs) while minimizing communication traffic. Private smart space allows each entity to set the shared portions of the smart space with different entities.

The processes described herein for applying execution context criteria for secure execution context sharing may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to apply execution context criteria for secure execution context sharing as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of providing separation of applying execution context criteria for secure execution context sharing.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to applying execution context criteria for secure execution context sharing. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for applying execution context criteria for secure execution context sharing. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for applying execution context criteria for secure execution context sharing, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 109 for applying execution context criteria for secure execution context sharing to the UE 101a-101n.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set 900 upon which an embodiment of the invention may be implemented. Chip set 900 is programmed to apply execution context criteria for secure execution context sharing as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 900, or a portion thereof, constitutes a means for performing one or more steps of applying execution context criteria for secure execution context sharing.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to apply execution context criteria for secure execution context sharing. The memory 905 also stores the data associated with or generated by the execution of the inventive steps.

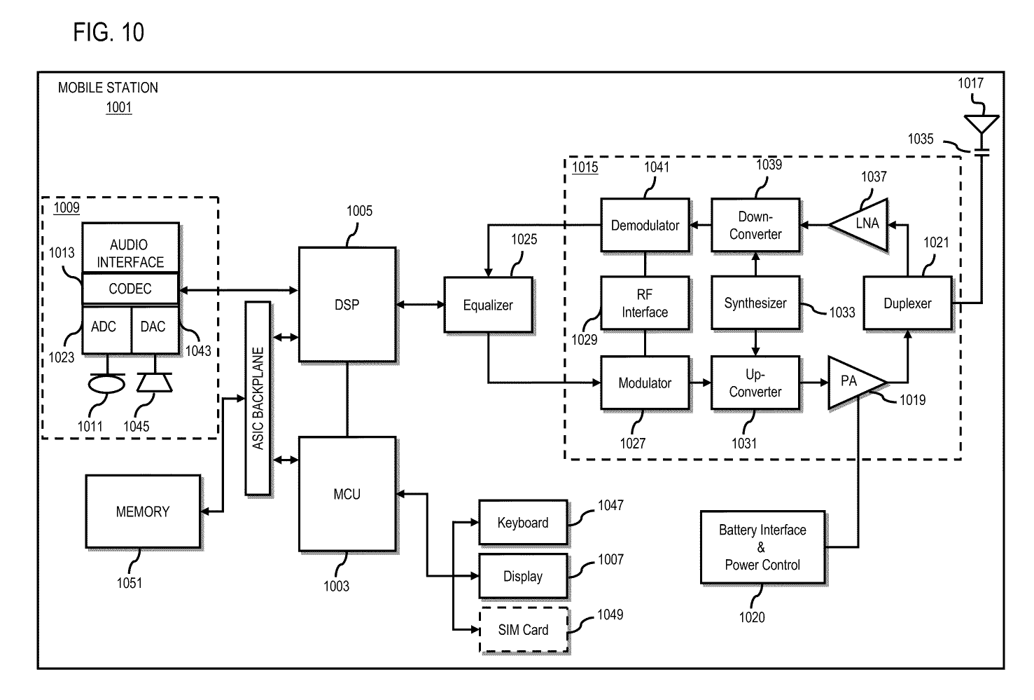

FIG. 10 is a diagram of exemplary components of a mobile terminal (e.g., handset) for communications, which is capable of operating in the system of FIG. 1, according to one embodiment. In some embodiments, mobile terminal 1000, or a portion thereof, constitutes a means for performing one or more steps of applying execution context criteria for secure execution context sharing. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of applying execution context criteria for secure execution context sharing. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to apply execution context criteria for secure execution context sharing. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
retrieving an execution context of a device;
determining one or more context criteria associated with the execution context, wherein the context criteria include state information associated with the execution context; and
encrypting the execution context using the one or more context criteria as a public key of an identity-based encryption.

2. A method of claim 1, further comprising:
causing, at least in part, publication of the encrypted execution context to an information store, a network service, a network storage, or a combination thereof,
wherein the encrypted execution context is retrieved or decrypted from the information store, the network service, the network storage, or the combination thereof based, at least in part, on meeting the context criteria.

3. A method of claim 1, further comprising:
selecting one or more parameters for conducting the identity-based encryption; and
causing, at least in part, storage of the parameters in an account of the information store.

4. A method of claim 1, further comprising:
selecting one or more layers of the execution context,
wherein the state information is retrieved from the one or more selected layers.

5. A method of claim 4, further comprising:
determining a level of granularity for the context criteria,
wherein the selecting of the layers of the execution context is based, at least in part, on the level of granularity.

6. A method of claim 4, wherein the one or more layers include a processor layer, an operating system layer, an application layer, a higher level layer, or a combination thereof.

7. A method of claim 1, wherein the context criteria further includes a processor or memory state, a technical requirement, an application preference, a content preference, an enforced condition, a sensed physical value, or a combination thereof.

8. A method of claim 1, further comprising:
causing, at least in part, abstraction of the execution context, the context criteria, or a combination thereof into an information structure,
wherein the encryption is further based, at least in part, on the abstraction.

9. An apparatus comprising:
at least one processor; and
at least one memory including computer program code for one or more computer programs,
the at least one memory and the computer program code configured to, with the at least one processor, cause the apparatus to perform at least the following,
retrieve an execution context;
determine one or more context criteria associated with the execution context, wherein the context criteria include state information associated with the execution context; and
encrypt the execution context using the one or more context criteria as a public key of an identity-based encryption.

10. An apparatus of claim 9, wherein the apparatus is further caused, at least in part, to:
cause, at least in part, publication of the encrypted execution context to an information store, a network service, a network storage, or a combination thereof,
wherein the encrypted execution context is retrieved or decrypted from the information store, the network service, the network storage, or the combination thereof based, at least in part, on meeting the context criteria.

11. An apparatus of claim 9, wherein the apparatus is further caused, at least in part, to:
select one or more parameters for conducting the identity-based encryption; and
cause, at least in part, storage of the parameters in an account of the information store.

12. An apparatus of claim 9, wherein the apparatus is further caused, at least in part, to:
select one or more layers of the execution context,
wherein the state information is retrieved from the one or more selected layers.

13. An apparatus of claim 12, wherein the apparatus is further caused, at least in part, to:
determine a level of granularity for the context criteria,
wherein the selecting of the layers of the execution context is based, at least in part, on the level of granularity.

14. An apparatus of claim 12, wherein the one or more layers include a processor layer, an operating system layer, an application layer, a higher level layer, or a combination thereof.

15. An apparatus of claim 9, wherein the context criteria further includes a processor or memory state, a technical requirement, an application preference, a content preference, an enforced condition, a sensed physical value, or a combination thereof.

16. An apparatus of claim 12, wherein the apparatus is further caused, at least in part, to:
cause, at least in part, abstraction of the execution context, the context criteria, or a combination thereof into an information structure,
wherein the encryption is further based, at least in part, on the abstraction.

17. A computer-readable storage medium carrying one or more sequences of one or more instructions which, when executed by one or more processors, cause an apparatus to at least perform the following steps:
retrieving an execution context;
determining one or more context criteria associated with the execution context, wherein the context criteria include state information associated with the execution context; and
encrypting the execution context using the one or more context criteria as a public key of an identity-based encryption.

18. A computer readable storage medium of claim 17, wherein the apparatus is caused to further perform:
causing, at least in part, publication of the encrypted execution context to an information store, a network service, a network storage, or a combination thereof,
wherein the encrypted execution context is retrieved or decrypted from the information store, the network service, the network storage, or the combination thereof based, at least in part, on meeting the context criteria.

19. A computer readable storage medium of claim 17, wherein the apparatus is caused to further perform:
selecting one or more parameters for conducting the identity-based encryption; and
causing, at least in part, storage of the parameters in an account of the information store.

20. A computer readable storage medium of claim 17, wherein the apparatus is caused to further perform:
selecting one or more layers of the execution context,
wherein the state information is retrieved from the one or more selected layers.

21-53. (canceled)
